(19) United States
(12) Patent Application Publication
(10) Pub. No.: US 2020/0023277 A1
(43) Pub. Date: Jan. 23, 2020

(54) SYSTEM AND METHOD FOR DYNAMIC MATCHMAKING IN CLIENT APPLICATIONS

(71) Applicant: MZ IP Holdings, LLC, Palo Alto, CA (US)

(72) Inventors: Harrison Chow, Mountain View, CA (US); Matt Walsh, San Carlos, CA (US)

(21) Appl. No.: 16/513,112

(22) Filed: Jul. 16, 2019

Related U.S. Application Data
(60) Provisional application No. 62/699,859, filed on Jul. 18, 2018.

(51) Int. Cl. A63F 13/795; A63F 13/798

(52) U.S. Cl. CPC A63F 13/795; A63F 13/798

(57) ABSTRACT

A method includes receiving a first request to perform matchmaking for a first user of a player-verses-player competition of a mobile application. In response to receiving the first request, the method further includes generating, by a computer processing device, a multi-level matchmaking plan for the first user based on a skill level of the first user. The method further includes determining a match for the first user based on the multi-level matchmaking plan. The method further includes providing the match to a client device corresponding to the first user for display.

### CROSS-REFERENCE TO RELATED APPLICATIONS

This application claims the benefit of U.S. Provisional Patent Application No. 62/699,859, filed Jul. 18, 2018, the entire contents of which are hereby incorporated by reference.

### BACKGROUND

In general, a multi-player online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players. Players may form such groups or teams using a matchmaking process.

### BRIEF DESCRIPTION OF THE DRAWINGS

FIG. 1 illustrates a first example system 100 for dynamic matchmaking in, for example, a massively multi-player online game or the like.

FIG. 2 illustrates a second example system 100 for dynamic matchmaking in, for example, a massively multi-player online game or the like.

FIG. 3 is a first flowchart of an example method for dynamic matchmaking in, for example, a massively multi-player online game or the like.

FIG. 4 is a second flowchart of an example method for dynamic matchmaking in, for example, a massively multi-player online game or the like.

FIG. 5 is a diagram of an example system architecture that may implement dynamic matchmaking in, for example, a massively multi-player online game or the like.

### DETAILED DESCRIPTION

Elements of examples or embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

The details of one or more embodiments of the subject matter described in this specification are set forth in the accompanying drawings and the description below. Other features, aspects, and advantages of the subject matter will become apparent from the description, the drawings, and the claims.

Systems and methods for dynamic matchmaking in client applications are described herein to overcome a variety of difficulties in traditional matchmaking. For example, in multiplayer computer games (e.g., massively multiplayer online (MMO) games and the like), matchmaking is the process of connecting players together for online play sessions. Players may be matched during matchmaking based on a variety of factors to generate matchups between users that yield interesting and competitive, but fair games. Establishing a suitable matchmaking framework poses numerous difficulties and entails various problems, not limited to optimizing user experiences, flexibility of use in a variety of game types, and scalability.

One issue associated with traditional matchmaking is that matchmaking seeks to solve a balance between time to match and providing quality matches. In theory, given infinite time and an endless pool of users, a perfect matchmaking system may be able to provide matchups that are likely to yield interesting, competitive, and fun games. In reality, the pool of users may be limited to users looking for a specific game at a given time, and that user is unlikely to wait long enough without getting matched to guarantee an ideal game.

In addition to this, what a particular user is likely to perceive as a fun match up may differ between users. Consequently, even if one were to design a system built to provide ideal games to a majority of users, there may still be users being matched in what they perceive to be less than ideal games.

Another issue may be that given a particular game, it may be common to design a matchmaker that specifically applies to that game and that type of game only. For example, for a matchmaker built specifically to arrange a 4-versus-4 (e.g., “4v4”) player game, it would identify eight match-seeking players and form two teams of four each. While such a system may work for that particular 4v4 game, innovation in games may require that other game types be supported, which can frequently come with varying the player counts. In the present example, a separate system would be needed to support another game type, where the number of players and number of teams may be different. Creating a separate system for each type of these game types can slow down development significantly, as it may involve managing what is potentially a complicated system to work for different players and potentially follow a different set of rules.

Further still, scalability may be an issue for current matchmaking systems. In one example, matchmaking could be attempted for a particularly large number of users at the same time. Taking an individual user and comparing that user to potentially the full range of other users available for matchmaking, and performing such comparisons for each other user in the matchmaking process, may scale linearly. Furthermore, producing matches based on a pool of users may be up to an O(n²) complexity algorithm. Consequently, there could be exponentially higher processing required as the users in matchmaking increase.

Advantageously, the system described herein overcomes the above issues, and others, by providing for dynamic matchmaking. In dynamic matchmaking, as described herein, a game-type-agnostic multi-level matchmaking plan may be generated to aid in the matchmaking process. Using the multi-level matchmaking plan, the embodiments described herein provide an optimized, game-type-independent, and scalable approach to matchmaking in mobile applications. Advantageously, the embodiments described herein can be used with any suitable client application that supports, desires to support, or otherwise incorporates matchmaking between users.

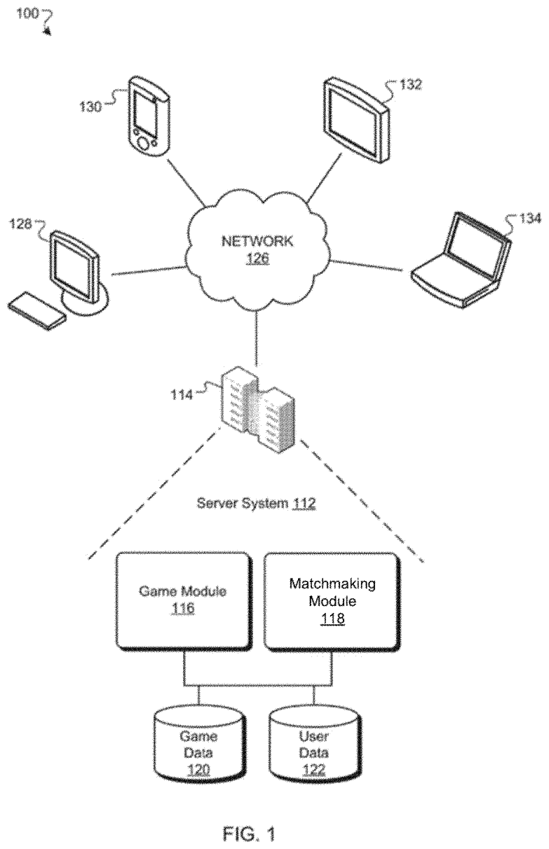

FIG. 1 illustrates an example system 100 for dynamic matchmaking in, for example, an online or mobile game, such as a massively multi-player online game or the like, or other suitable client application. A server system 112 provides functionality for providing the online game to a plurality of users and for providing dynamic matchmaking in the online game. The server system 112 includes software components and databases that can be deployed at one or more data centers 114 in one or more geographic locations, for example. The server system 112 software components can include a game module 116 and a matchmaking module 118. The software components can include subcomponents that can execute on the same or on different individual data processing apparatus. The server system 112 databases can include game data 120 and user data 122 databases. The databases can reside in one or more physical storage systems. The software components and data will be further described below.

An application, such as, for example, a web-based application, can be provided as an end-user application to allow users to interact with the server system 112. The end-user application can be accessed through a network 126 (e.g., the Internet, a LAN, a WAN, and the like) by users of client devices, such as a personal computer 128, a smart phone 130, a tablet computer 132, and a laptop computer 134. Other client devices are possible. In alternative examples, the game data 120 database and/or the user data 122 database or any portions thereof can be stored on one or more client devices. Additionally or alternatively, software components for the system 100 (e.g., the game module 116 and/or the matchmaking module 118) or any portions thereof can reside on or be used to perform operations on one or more client devices.

FIG. 1 depicts the game module 116 and the matchmaking module 118 as being able to communicate with the databases (e.g., the game data 120 and the user data 122 databases). The game data 120 database generally includes information related to the online or mobile game (e.g., a multi-player online game) or other client application implemented using the system 100. For the embodiment of an online or mobile game, the game data 120 database can include, for example, information related to a virtual environment for the game, image, video and/or audio data for the game, event data corresponding to previous, current or future game events, and/or game state data defining a current state of the game. The user data 122 database generally includes data related to users and user interactions with the online game and/or the virtual environment. Such information can be or include, for example, a history of user connections to the system 100, user purchases, user accomplishments, user levels, user tasks, user interactions with other users (e.g., group chats), user virtual item acquisition or usage, and/or other user conditions in the virtual environment and/or real world. The user data 122 database can include information related to matchmaking pools. Such information can include, for example, a hash-based cache of users categorized into specific matchmaking pools, as described herein.

In various examples, the users or players of the online game or other suitable web-based application can have certain user capabilities in the virtual environment. For the embodiment of an online or mobile game, the user capabilities can be or include, for example, moving an avatar or a virtual item or object to a different geographical location, interacting with characters or other users, participating in user groups or alliances, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible.

The virtual environment for the online game or other suitable web-based application can be rendered for users in the form of, for example, graphics, images, video, audio, text, and/or haptic feedback. In an adventure game, for example, a graphical user interface can display a virtual environment that includes representations of characters (e.g., people or animals), natural features (e.g., mountains, rivers, fields, trees, and/or weather conditions), and/or man-made features (e.g., buildings, bridges, and/or vehicles).

In some examples, users can earn points or other assets in the online game by performing tasks or reaching certain goals, including, for example: winning a match or group of matches against a computer or other user; eliminating a quantity of another user's resources (e.g., one point per eliminated enemy troop); discovering a quantity of a virtual resource (e.g., one point per hidden gold coin discovered in a virtual environment); participating in a mini-game that can support the online game (e.g., one point per spin of a virtual slot machine); crafting or building a virtual item (e.g., one point for building a virtual weapon); increasing user level or user power (e.g., one point per unit increase in user power); and/or using a new game feature (e.g., one point for using a newly released virtual item). Other ways of earning points in the online game are possible. In various examples, rewards earned in an online game can be or include, for example, virtual goods, virtual resources, new user titles (e.g., “Tournament Champion” or “Prince of the Realm”), new graphical elements (e.g., a glow, color change, or decorations at a user location or for user items), special limited or early release items (e.g., permit user to be a first user of a new game feature or item), and/or cryptocurrency payouts.

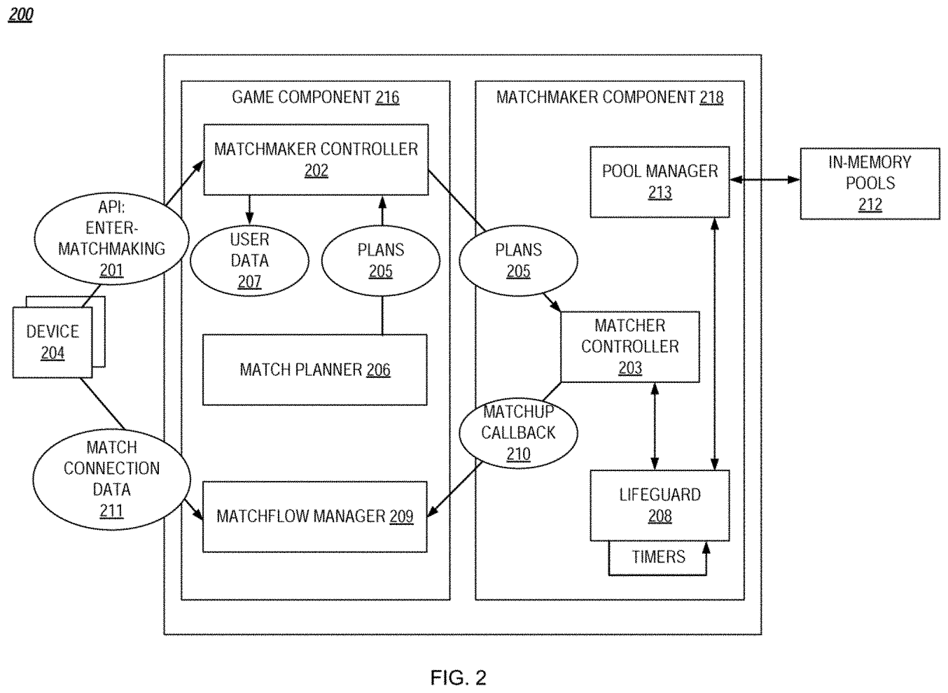

Game module 116 and matchmaker module 118 are described further with respect to FIG. 2, below.

FIG. 2 illustrates a second example system 200 for dynamic matchmaking in, for example, a massively multi-player online game or the like. In one embodiment, system 200 provides a more detailed view of system 100. For example, Game Component 216 may be substantially the same or similar to game module 116 of FIG. 1, and Matchmaker Component 218 may be the same or substantially similar to matchmaking module 118 of FIG. 1.

System 200 includes a variety of optional components, each of which will be described along with respect to their functionality herein. Notably, actions described as being performed by any of the components or subcomponents herein may alternatively or additionally be performed by any other component or subcomponent.

In one embodiment, Matchmaker Controller 202 may receive an “enter matchmaking” request 201 from a client device (e.g., client device 204). Matchmaker Controller 202 may then build (or retrieve) a Matchmaking Plan 205 for Matcher Controller 203 of Matchmaker Component 218.

In one embodiment, a plan (e.g., Matchmaking Plan 205) is a collection of Matchmaker Actions (e.g., levels, as described herein). Action parameters that may be used to generate a plan may include, for example, game type (e.g., 1v1, 2v2, etc.), ELO/ELO range (or some other appropriate way of classifying a user's skill level), and duration (e.g., an amount of time to spend in a level before taking the next action).

In one embodiment, Match Planner 206 is responsible for generating Matchmaking Plans 205. Given a user (e.g., identified by User Data 207), Match Planner 206 may provide a Matchmaking Plan 205 that is comprised of multiple levels, where each level corresponds to, for example, a skill-level range and a duration of time. Such ranges and durations may be user configurable, and/or dynamically generated by the embodiments described herein. An example matchmaking plan for a 2-versus-2 (“2v2”) game is provided below with respect to Table 1.

TABLE 1
Example of Matchmaking Plan

| Step | Game Type | ELO Range | Duration |
|---|---|---|---|
| 1 | 2v2 | 1490-1510 | 5 seconds |
| 2 | 2v2 | 1450-1550 | 10 seconds |
| 3 | 2v2 | 1400-1600 | 20 seconds |

In one embodiment, Lifeguard 208 is a manager of matchmaking levels. Lifeguard 208 may execute each action (e.g., step, level) in a matchmaking plan. Lifeguard 208 may, for example, spin up timers to execute the next action, add/remove users to/from Matchmaker Pools 212 (e.g., via a Pool Manager 213) associated with particular levels as necessary, etc. In one embodiment, Pool Manager 213 acts as a wrapper to transactionally add and remove players from Matchmaker Pools 212.

In one embodiment, Match Flow Manager 209 receives matchup callbacks 210 from Match Controller 203 about matches made, constructs backend match object entries, and/or reports Match Connection Data 211 to the client device 204.

In one embodiment, the system 200 may implement a variety of other features. For example, dynamic matchmaking via system 200 may include a memory of recently previously matched opponents. As an optional consideration, players who have matched recently (e.g., within some time threshold) may be prevented from matching again for a defined duration. Optionally, system 200 may include a guaranteed maximum difference of ELOs feature, such that players may never be matched when the difference between their respective ELOs exceeds a defined threshold. Furthermore, an expert match planner user interface, with access to User Data 207, may be provided by system 200 to display which deck is being played by the user, how much the user spent, etc., in order to construct an advanced plan per user.

An example operational flow corresponding to system 200 is provided below. In one embodiment, the present embodiments achieve dynamic, optimized matchmaking in a mobile or online application (e.g., an online multiplayer game, such as, for example, a massively multiplayer online (MMO) game and the like) for a particular user by constructing a Matchmaking Plan (e.g., Matchmaking Plan 205) when he or she enters a matchmaking phase. It is noted that a single Matchmaking Plan 205 can be constructed for and applied to more than one user, such as to groups of users that share a similar characteristic, metric, or other parameter (e.g., ELO rating, as discussed in more detail below). In one example, merely for purposes of illustration of one embodiment of the present invention and not limitation, the following discussion pertains to the generation and execution of a Matchmaking Plan 205 for a particular user.

In one embodiment, executing the Matchmaking Plan 205 may include one or more steps, each with variable per-step maximum time durations that specify parameters around the best way to match the particular user based on identifiable attributes. For purposes of illustration and not limitation, in the example in Table 1 (reproduced below), a Matchmaking Plan 205 has been established to attempt to group players for a 2v2 game to minimize differences between their measured skill levels.

TABLE 1
Example Matchmaking Plan

| Step | Game Type | ELO Range | Duration |
|---|---|---|---|
| 1 | 2v2 | 1490-1510 | 5 seconds |
| 2 | 2v2 | 1450-1550 | 10 seconds |
| 3 | 2v2 | 1400-1600 | 20 seconds |

According to one embodiment, the ELO rating system can be used to calculate and measure the relative skill levels of the players, although other suitable skill level rating or common ranking systems can be used. The ELO rating can be calculated at the end of each significant competitive event in the mobile or online application (e.g., a battle), where the rating increases/decreases based on the expected outcome of battle and the actual result. In one embodiment, ELO ranges can be centered around a user's ELO rating. In another embodiment, ELO ranges can be centered around a number that is based on a user's ELO rating (e.g., centered around multiples of 20, 50, 100, etc. that are close to a user's ELO rating).

In one embodiment, once the plan has been constructed, the present embodiments start searching in the ELO range specified by the first step for other users searching for that game type who also have an ELO rating within the specified range. If the specified duration of the first step expires without a match up, the present embodiment can proceed to the second step and start searching within that range as well. Any suitable number of steps, ranges, and durations can be specified in the Matchmaking Plan 205. The search can continue in additional steps (e.g., each subsequent step having an expanded ELO range and longer duration) until the present invention finds what should be close to the best matchup for that user at the time while attempting to minimize wait time.

To construct the Matchmaking Plan 205, the present embodiments can use a Match Planner 206 or other similar module that can be configured to automatically generate buckets (such as the buckets illustrated in Table 1) of users based on suitable configuration values that may be dynamically modified by an administrator or other system component in response to, for example, feedback that is obtained from monitoring data in the mobile application. Such a Match Planner 206 can be a component of a system (e.g., system 200 illustrated in FIG. 2) that, based on a configurable set of parameters about a user entering matchmaking (e.g., information about how long the user has played, what time of day they are entering matchmaking, whether a user is on a losing streak, etc.), can apply a customized plan to the user upon entry into the mobile or online application.

More particularly, in one embodiment, the plan constructor (e.g., Match Planner 206) has a well-defined interface to generate plans. In the example of a mobile or online game, such an interface can accept various types of information, including, but not limited to: a reference to data for the user who is entering matchmaking; information about the game type the user desires to play (e.g., 2v2, 3v3, etc.); and information about the current state of the game environment. The Match Planner 206 can then put together or otherwise build or generate a Matchmaking Plan 205 based on the provided information. In the context of a mobile or online game, an example of a basic Match Planner 206 would be one that can take a user's current ELO (as ELO is re-calculated on receiving the result of each match) and constructs ranges around that ELO that progressively get larger in each subsequent level/step for a plan that strategizes to sacrifice time for accuracy. Alternatively, a Match Planner 206 that is optimized for match throughput in response to saturation of users in the system may look at that player count as a part of the input. In such an instance, if the count is higher, the Match Planner 206 may specify shorter durations for each match level/step in order to get a user matched more quickly. One advantage to allowing for various Match Planners 206 to be integrated into the present system is to allow for better customization of the matchmaking experience for each game type that may require matchmaking.

System 200 provides a number of improvements over current systems. For example, in one embodiment in the context of mobile or online games, system 200 is game-type agnostic, e.g., the game's type can be specified going into the matchmaking system and the embodiments described herein are able to configure how many players it needs for the match it is searching for, allowing for the general matchmaking system to support multiple game types without additional configuration and/or modification.

In another embodiment, to address the issue of scalability, generation of the Matchmaking Plan 205 can include individual user computation up front by creating the plan entries. Each plan step can then be converted into string keys to be used by the matchmaker to place users into a hash-based cache. These hash buckets can then act as the comparison step for users, where instead of explicitly checking all other users, users entering buckets are effectively pre-screened as compatible matchups. This means that the processing only needs to happen once per user, reducing the search complexity to a point that it approaches O(1).

In another embodiment, in the event that the present system detects a saturation of users in matchmaking, the Match Planner 206 can modify its behavior to prioritize throughput over match quality by placing users in more generic buckets. Alternatively, the wait time can be decreased between steps in order to allow the present invention to search in multiple places (e.g., buckets) faster. In the ELO-based example, this could be achieved by increasing the range of the search ELO and/or decreasing the earlier step durations.

A specific example of the utilization of system 200 to provide dynamic matchmaking in a mobile or online game is provided below. In the current example, Alice requests to enter 1v1 matchmaking with an ELO of 1000. Match Planner 206 returns a plan with three actions: (1) a narrow bucket with a range of +/−50 ELO centered around 1000 (e.g., 950-1050 ELO) for 5 seconds; (2) a wide bucket with a range of +/−100 ELO centered around 1000 (e.g., 900-1100 ELO) for 10 seconds; and (3) a fallback bucket with indefinite range and duration.

On entry, Alice's narrow bucket is empty, so she waits there (her information may be hashed, cached, and stored in one or more buckets). Subsequently, Bob requests to enter 1v1 matchmaking with an ELO of 1040. Match Planner 206 returns a plan with three actions: (1) a narrow bucket with a range of +/−50 ELO centered around 1050 (e.g., 1000-1100 ELO) for 5 seconds; (2) a wide bucket with a range of +/−100 ELO centered around 1000 (e.g., 900-1100 ELO) for 10 seconds; and (3) a fallback bucket with indefinite range and duration. Bob's narrow bucket pool is empty on entry, so he waits there.

In one embodiment, Match Planner 206 generates bucket keys that are common enough that they collide (e.g., “match). Because of this, Bob's range may be defined around 1050 (e.g., as opposed to his ELO score of 1040), since that may be a predefined “center” the match planner may pick for him (e.g., in multiples of 50 or any other suitable increment). As a result, with Alice's ELO of 1000, and Bob's ELO of 1040, Match Planner 206 may determine first picks centered around 1000 and 1050, respectively, so they do not match as a result. In one embodiment, matches are determined by colliding ELO values. Here, Alice and Bob have ELO values centered around 1000 and 1050, respectively, so they do not match. In another embodiment, matches may be determined by overlapping ELO ranges.

In the next step, the ranges are wider (e.g., +/−100), and so are the centers. Consequently, the centers of Alice and Bob may both be determined to be 1000 (e.g., 1000 is the closest multiple of 100 to both Alice's ELO of 1000 and Bob's ELO of 1040), which would put both Bon and Alice in the same pool (e.g., because of their colliding centered ELO values). Returning to the flow of the current example, after waiting the duration of her first action, Alice's wide bucket pool is empty on entry, so she additionally waits there. Bob's wide bucket pool has Alice in it (e.g., they are both centered around 1000), and since they just need two players for a 1v1 game, they are made a match.

In another example, Charlie, having a 1020 ELO and a first bucket centered around 1000 (e.g., the closest multiple of 50), enters after Alice enters her second action, but before Bob hits his second action. Charlie immediately matches against Alice (e.g., they both have ELO values centered around 1000), removing Charlie and Alice from all their pools. Bob moves to his second action, and no one is there, so he waits in his pools.

Dave enters 2v2 matchmaking in the middle of this process. He would not match to the others, as 1v1 and other game types are a separate set of buckets, similar to how different versions, cohorts, etc. would not match. Dave would need to wait until three additional users (e.g., all of whom desire to enter 2v2 matchmaking) are available in his bucket before matching for 2v2.

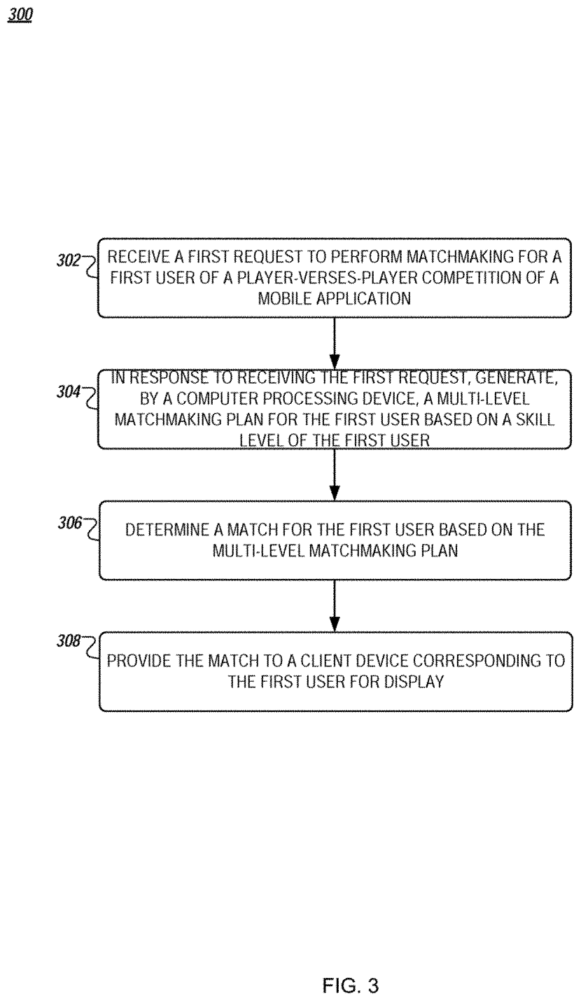

Merely for purposes of illustration and not limitation, FIG. 3 is a first flowchart of an example method 300 for dynamic matchmaking in, for example, an online or mobile application, such as a massively multi-player online game or the like. In certain embodiments, the method 300 may be performed by processing logic that may include hardware such as one or more computer processing devices, software (e.g., instructions running/executing on a computer processing device), firmware (e.g., microcode), or a combination thereof, such as the system 200 discussed above with respect to FIG. 2.

The method 300 may begin with processing logic receiving a first request to perform matchmaking for a first user (e.g., “player”) of a player-verses-player competition of a mobile application. In one embodiment, the request includes a variety of information. For example, in one embodiment, the request may identify the user and/or user device. In another embodiment, the request may identify a number of players to be matched in the player-verses-player competition of the mobile application (where a matchmaking plan is based on the number of players identified). In another embodiment, additional information may be included, such as an identification of the game, game characteristics, user preferences, user skill level, etc.

At block 304, in response to receiving the first request, processing logic generates (e.g., by a computer processing device) a multi-level matchmaking plan for the first user based on a skill level of the first user. In one embodiment, the multi-level matchmaking plan may be dynamically generated based on user information received and/or determined. In one embodiment, the multi-level matchmaking plan includes at least two levels (e.g., activities), but any number of levels may be included.

In a variety of embodiments, each level of the multi-level matchmaking plan corresponds to a range of skill levels (e.g., ELOs) and a search duration, respectively (e.g., see Table 1, above). Each of the ranges of skill levels may be based on a skill level of the first user (e.g., within some threshold skill level of the first user). In one embodiment, the range of skill levels and corresponding search duration for each level increase for increasing levels of the matchmaking plan. In other words, the range of skill levels gets increasingly broad as the levels progress, and the duration of time a user is to spend at each level gets increasingly longer. In one embodiment, at least one of the range of skill levels or the search duration for each level is based on a match throughput characteristic. For example, when throughput is a priority, ranges of skill levels may be broadened and/or durations may be shorted.

At block 306, processing logic determines a match for the first user (e.g., matches the first user to one or more other users) based on the multi-level matchmaking plan. In one embodiment, users may be matched as opponents. In another embodiment, using the same systems and methods described herein, users may be matched as teammates.

At block 308, processing logic provides the match (e.g., an indication of the match, and optionally additional information about the users in the match) to a client device corresponding to the first user for display. In one embodiment, the user, once presented with the match and any other relevant information, may accept or decline the match. In another embodiment, the match can be automatically accepted (e.g., without human interaction). In one embodiment, secondary considerations may cause processing logic to accept or reject a match on behalf of a user. For example, processing logic may prevent the matching of two users who have previously matched within some threshold of time. In another embodiment, each user may provide match preferences, and processing logic may decline otherwise eligible matches based on such user preferences. For example, a user may indicate that he or she only wants to be matched with someone within a threshold age, distance, skill level, experience, etc. as the user.

Optionally, processing logic may receive a second request to perform matchmaking for a second user of the player-verses-player competition of an online or mobile application. In response to receiving the second request, processing logic may determine that the second user shares a similar characteristic to the first user. Further, in response to the determining, processing logic may determine a match for the second user based on the multi-level matchmaking plan without generating a new matchmaking plan.

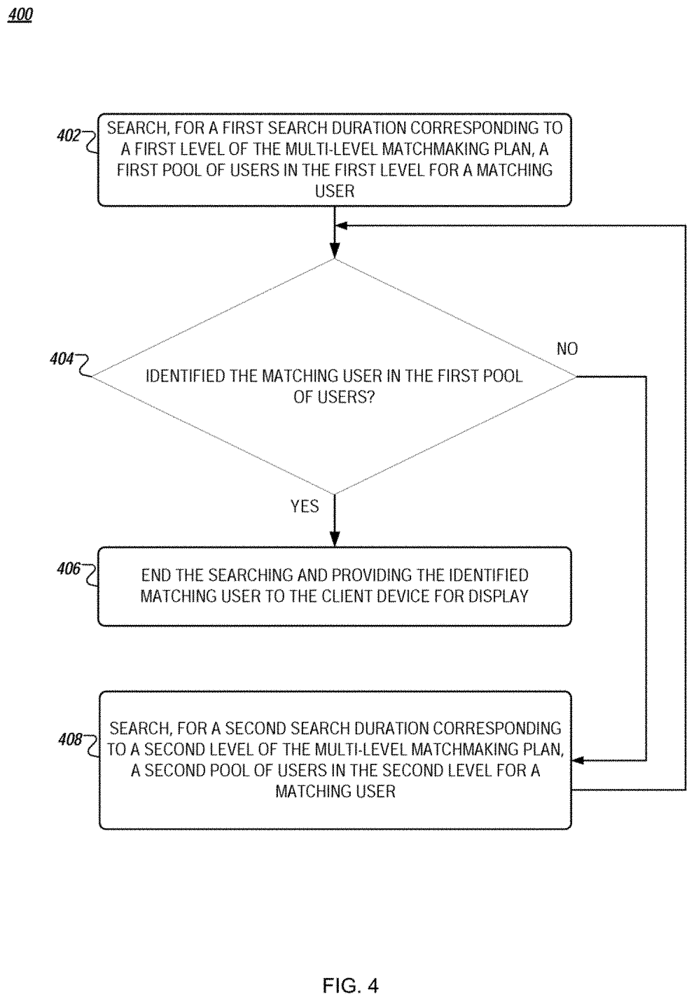

Merely for purposes of illustration and not limitation, FIG. 4 is a second flowchart of an example method 400 for dynamic matchmaking in, for example, a massively multi-player online game or the like. In certain embodiments, the method 400 may be performed by processing logic that may include hardware such as one or more computer processing devices, software (e.g., instructions running/executing on a computer processing device), firmware (e.g., microcode), or a combination thereof, such as the system 200 discussed above with respect to FIG. 2.

To determine the match at block 306 of FIG. 3, processing logic may search, for a first search duration corresponding to a first level of the multi-level matchmaking plan, a first pool of users in the first level for a matching user (block 402). At block 404, processing logic determines whether a matching user is identified in the first level (e.g., first pool of users). At block 406, in response to identifying the matching user in the first pool of users, processing logic ends the searching and provides the identified matching user to the client device for display (optionally along with any other suitable information and/or option to accept or decline the matchup). At block 408, in response to failing to identify the matching user in the first pool of users, processing logic searches, for a second search duration corresponding to a second level of the multi-level matchmaking plan, a second pool of users in the second level for a matching user. This process may repeat until a suitable match is found.

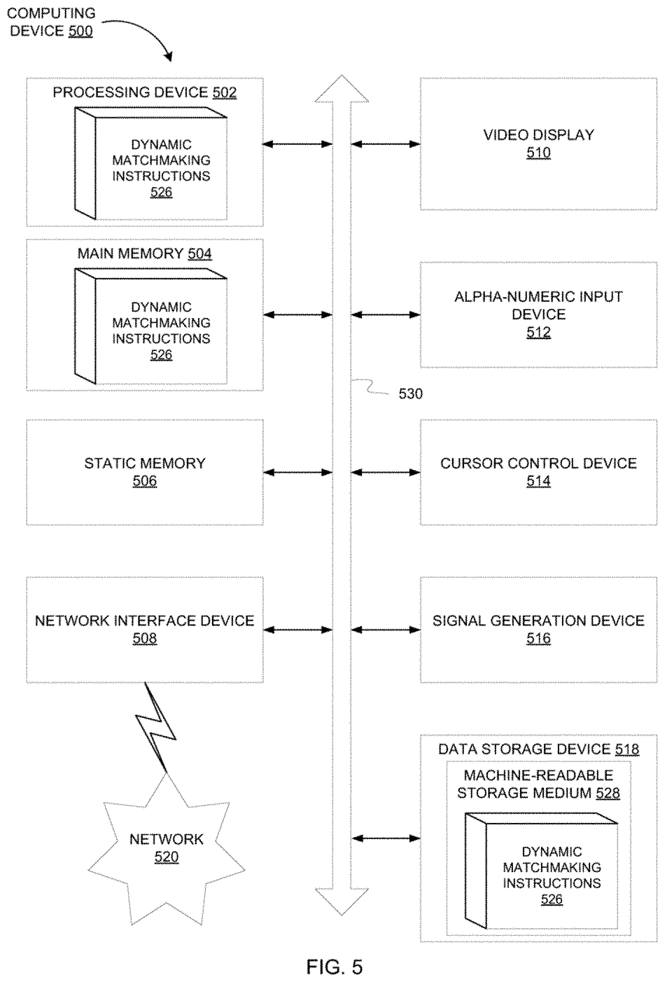

FIG. 5 is a block diagram of an example computing device 500 that may perform one or more of the operations described herein, in accordance with the present embodiments. In various embodiments, computing device 500 may represent computing devices (e.g., servers) of the experimentation platform, third-party content provider client devices, and/or third-party content provider servers. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpoxse processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 526, e.g., instructions for carrying out the operations described herein, in accordance with one or more aspects of the present disclosure. Dynamic matchmaking instructions 526 may also reside, completely or at least partially, within main memory 504 and/or within processing device 502 during execution thereof by computing device 500, main memory 504 and processing device 502 also constituting computer-readable media. The instructions 526 may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s)

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
receiving a first request to perform matchmaking for a first user of a player-verses-player competition of a mobile application;
in response to receiving the first request, generating, by a computer processing device, a multi-level matchmaking plan for the first user based on a skill level of the first user;
determining a match for the first user based on the multi-level matchmaking plan; and
providing the match to a client device corresponding to the first user for display.

2. The method of claim 1, wherein each level of the multi-level matchmaking plan corresponds to a range of skill levels and a search duration.

3. The method of claim 2, wherein the range of skill levels and corresponding search duration for each level increase for increasing levels of the matchmaking plan.

4. The method of claim 3, wherein determining the match comprises:
searching, for a first search duration corresponding to a first level of the multi-level matchmaking plan, a first pool of users in the first level for a matching user;
in response to identifying the matching user in the first pool of users, ending the searching and providing the identified matching user to the client device for display; and
in response to failing to identify the matching user is the first pool of users, searching, for a second search duration corresponding to a second level of the multi-level matchmaking plan, a second pool of users in the second level for a matching user.

5. The method of claim 2, wherein the range of skill levels for each level is within a predetermined threshold of the skill level of the first user.

6. The method of claim 2, wherein at least one of the range of skill levels or the search duration for each level is based on a match throughput characteristic.

7. The method of claim 1, wherein the first request identifies a number of players to be matched in the player-verses-player competition of the mobile application, and wherein the matchmaking plan is based on the number of players.

8. The method of claim 1, further comprising:
receiving a second request to perform matchmaking for a second user of the player-verses-player competition of the mobile application;
determining that the second user shares a similar characteristic to the first user, and
in response to the determining, determining a match for the second user based on the multi-level matchmaking plan without generating a new matchmaking plan.

9. A multi-level matchmaking system, comprising:
a memory to store a multi-level matchmaking plan; and
a computer processing device, operatively coupled to the memory, to:
receive a first request to perform matchmaking for a first user of a player-verses-player competition of a mobile application;
in response to receiving the first request, generate the multi-level matchmaking plan for the first user based on a skill level of the first user;
determine a match for the first user based on the multi-level matchmaking plan; and
provide the match to a client device corresponding to the first user for display.

10. The multi-level matchmaking system of claim 9, wherein each level of the multi-level matchmaking plan corresponds to a range of skill levels and a search duration.

11. The multi-level matchmaking system of claim 10, wherein the range of skill levels and corresponding search duration for each level increase for increasing levels of the matchmaking plan.

12. The multi-level matchmaking system of claim 11, wherein to determine the match the computer processing device is to:
search, for a first search duration corresponding to a first level of the multi-level matchmaking plan, a first pool of users in the first level for a matching user;
in response to identifying the matching user in the first pool of users, end the searching and provide the identified matching user to the client device for display; and
in response to failing to identify the matching user is the first pool of users, search, for a second search duration corresponding to a second level of the multi-level matchmaking plan, a second pool of users in the second level for a matching user.

13. The multi-level matchmaking system of claim 10, wherein the range of skill levels for each level is within a predetermined threshold of the skill level of the first user.

14. The multi-level matchmaking system of claim 10, wherein at least one of the range of skill levels or the search duration for each level is based on a match throughput characteristic.

15. The multi-level matchmaking system of claim 9, wherein the first request identifies a number of players to be matched in the player-verses-player competition of the mobile application, and wherein the matchmaking plan is based on the number of players.

16. The multi-level matchmaking system of claim 9, the computer processing device further to:
receive a second request to perform matchmaking for a second user of the player-verses-player competition of the mobile application;
determine that the second user shares a similar characteristic to the first user, and
in response to the determining, determine a match for the second user based on the multi-level matchmaking plan without generating a new matchmaking plan.

17. A non-transitory computer-readable storage medium including instructions that, when executed by a computer processing device, cause the computer processing device to:
receive a first request to perform matchmaking for a first user of a player-verses-player competition of a mobile application;
in response to receiving the first request, generate, by the computer processing device, a multi-level matchmaking plan for the first user based on a skill level of the first user,
determine a match for the first user based on the multi-level matchmaking plan; and
provide the match to a client device corresponding to the first user for display.

18. The non-transitory computer-readable storage medium of claim 17, wherein each level of the multi-level matchmaking plan corresponds to a range of skill levels and a search duration.

19. The non-transitory computer-readable storage medium of claim 18, wherein the range of skill levels and corresponding search duration for each level increase for increasing levels of the matchmaking plan.

20. The non-transitory computer-readable storage medium of claim 19, wherein to determine the match the computer processing device is to:
search, for a first search duration corresponding to a first level of the multi-level matchmaking plan, a first pool of users in the first level for a matching user;
in response to identifying the matching user in the first pool of users, end the searching and provide the identified matching user to the client device for display; and
in response to failing to identify the matching user is the first pool of users, search, for a second search duration corresponding to a second level of the multi-level matchmaking plan, a second pool of users in the second level for a matching user.
